(19) United States
(12) Patent Application Publication
(10) Pub. No.: US 2014/0355494 A1
(43) Pub. Date: Dec. 4, 2014

(54) Overhearing

(71) Applicant: Broadcom Corporation, Irvine, CA (US)

(72) Inventors: Tommi Tapani JOKELA, Helsinki (FI); Hongnian XING, Espoo (FI)

(73) Assignee: Broadcom Corporation, Irvine, CA (US)

(21) Appl. No.: 14/287,591

(22) Filed: May 27, 2014

(30) Foreign Application Priority Data
May 28, 2013 (GB) 1309501.3

(51) Int. Cl. H04W 72/04; H04L 5/14; H04L 5/00

(52) U.S. Cl. CPC H04W 72/0446; H04L 5/003; H04L 5/1469; H04W 92/10
USPC 370/280; 370/336

(57) ABSTRACT

A method for use by a base station of a communication network is provided, the base station belonging to a first group of base stations and the communication network comprising the first group of base stations and second and third groups of base stations. The base station provides access to the communication network for user equipments by communicating with the user equipments via an air interface. The method comprising allocating (S11) overhearing uplink resources to be used for receiving data from base stations of the second and third groups, in a frame used for communicating with the user equipments, and allocating (S12) overhearing downlink resources for the second and third groups, to be used for transmitting data to base stations of the second and third groups, in the frame used for communicating with the user equipments.

### TECHNICAL FIELD

The present disclosure relates to overhearing. In particular, but not exclusively, the present disclosure relates to measures, including methods, apparatus and computer program products for base station overhearing for local area cells.

### BACKGROUND

Prior art which is related to this technical field can e.g. be found in the U.S. patent publication no. US 2011/0243107A (hereinafter, referred as to reference [1]).

The following meanings for the abbreviations used in this specification apply:

### 3GPP Third Generation Partnership Project

BS base station
CAPEX capital expenditure
CDM code division multiplexing
CoMP coordinated multi-point access
CP cyclic prefix
DL/UL downlink/uplink
FDD frequency domain division
FD-ICIC frequency domain inter-cell interference coordination
GP guard period
HO handover
IC interference cancellation
ICI inter-cell interference
LA local area

### LTE Long Term Evolution

OFDM orthogonal frequency division multiplexing
PDCCH physical downlink control channel
POCH physical overhearing channel
PRB physical resource block
PUCCH physical uplink control channel
PUSCH physical uplink shared channel
QPSK quadrature phase-shift keying
RAT radio access technology
SON self-organized/optimized network
SRS sounding reference signal
TDD time domain division
TDM time division multiplexing
UE user equipment

One potential problem for a wireless network operator in a future wireless network is the lack of network capacity. This requires an operator to find some new radio resources (spectrum) for extending the service and/or improving the service quality, or alternatively to improve the efficiency of the currently available resources.

The efficiency of a communication system can be improved either at a link or network level. As predicted by the Shannon theory, the capacity of a modern communication system, such as 3GPP LTE, cannot be significantly improved by the means of generic link level techniques, such as modulation, coding, and diversity.

As a consequence, network level improvements are becoming increasingly attractive. The network level efficiency may be improved either by means of network self-optimization or network coordination optimization. Network self-optimization is usually performed for a single network using a single radio access technology (RAT) (for a certain operator), whilst network coordination optimization implies coordinating the resources under different RATs (from different operators).

Reference [1] is concerned with BS-BS communication through air link. Reference proposes setting up the air link between BSs with the help of UE(s). Furthermore an extended guard period (GP) in a special subframe is proposed for the communication. Although reference [1] aims at the procedure of building a link between two base stations, there is a problem of how to set up the links from the network point of view so that all the base stations may communicate with their neighbors with a limited overhead and reasonable delay. Another problem involved is how to utilize the available resources utilized for the information exchange between base stations.

### BRIEF DESCRIPTION OF THE DRAWINGS

FIG. 1 shows a flowchart illustrating a BS overhearing method according to an example version of the disclosure.

FIGS. 2A-2C show diagrams illustrating uplink/downlink operation states of cells with respect to a BS overhearing method according to an example version of the disclosure, at time units #1, #2 and #3.

FIG. 3 shows a diagram illustrating a GP/OFDM symbol based frame structure used for overhearing according to an example version of the disclosure.

FIG. 4 shows a diagram illustrating special subframe configurations in LTE.

FIG. 5 shows a schematic block diagram illustrating a configuration of control units in which examples of versions of the disclosure may be implemented.

### DETAILED DESCRIPTION

Regarding the present disclosure, considerable approaches for resolving possible issues incurred under the lack of network capacity are reviewed. One potential approach for improving the system efficiency is to reduce the cell size, consequently improving the system capacity. In such a “local area” deployment, either link or system level architecture may be improved due to changes in the transmission conditions. One example of a local area deployment is the concept of femto-cells which are widely used in today's third generation (3G) and fourth generation (4G) systems.

Interference management is one of the critical issues for wireless networks due to the fact that cell edge performance has a significant impact on the overall network performance. This is especially the case for local area deployments where the traffic load typically changes in a dynamic manner. Furthermore, for local area time domain division (TDD) deployments supporting a flexible TDD switching point, there may be a significant amount of inter-cell interference (ICI), such as cross-link downlink/uplink (DL/UL) interference. In such cases, interference management is expected to be a crucial factor for an efficient network deployment.

In 3GPP LTE release 8, frequency domain inter-cell interference coordination (FD-ICIC) may be applied to mitigate interference from neighboring cells. The simplest way is to use different physical resource blocks (PRBs) in inner and outer parts of the cells to avoid the ICI. However, such a management scheme is quite inflexible, implying low efficiency. More advanced schemes, such as those based on time domain ICIC (TD-ICIC), have been adopted in long term evolution (LTE) releases 10-11 so that the most interfered elements (user equipment (UEs) and base station (BSs)) may be allocated to orthogonal resources. Even more elaborate ICIC schemes might be needed in LTE Release-12 in order to mitigate cross-link interference due to flexible TDD operation.

Problems lie in at least two aspects:

Aspect 1: The coordination, which requires fast information exchange between cells, is a necessary condition for the system.

Aspect 2: The link used for the coordination may not exist, or the delay of the link is not acceptable.

For the first aspect, ICIC and interference cancellation (IC) are key features for interference-limited network deployments, and they potentially have a significant contribution on the overall network performance. Being able to exchange information between cells is typically needed for a successful deployment of ICIC algorithms.

Some ICIC schemes/algorithms, such as the FD-ICIC in 3GPP release 8, are based on static/semi-static resource coordination. As a consequence, no fast information exchange between neighboring cells is needed. However, due to the semi-static nature of these schemes, there are some significant drawbacks:
System/spectrum efficiency and flexibility are impacted due to semi-static scheduling. That is, some of the free resources might not be available for the scheduling, even when there is no interference at that time.
Link level performance is limited since the best available frequencies may not be selected due to the static scheduling.

More problems are expected to arise in systems supporting a flexible TDD switching point. In particular, there may be significant cross-link interference during subframes where one base station is transmitting and the other is receiving. Dynamic coordination will be needed in such cases in order to track changes in the TDD switching point stemming from the fluctuations in cell load.

Hence, two requirements arise from the assumption of a flexible TDD switching point:
There is a clear need for information exchange between adjacent base stations; and
The information exchange rate has to be high enough for successful coordination of the ICI.

For the second aspect, availability of the BS-BS interface in LTE deployments is important, and whether the delay of such an interface is sufficient for the intended coordination scheme:
In many cases there might be no BS-BS interface (X2) between two local area (LA) cells. In general, the LA cell is much smaller than the current macro cell, and as a result, the density of LA nodes per area unit is much higher than the macro nodes per area unit. In fact, it has been recently discussed in 3GPP whether a network deployment comprising potentially hundreds of X2 links per macro cell would be feasible at all from the capital expenditure (CAPEX) point of view. Furthermore, aspects such as terrain, security, and infrastructure, are expected to impose some further limitations on the availability of X2.
From a latency point of view, it is expected that most of the ICIC related functions can be supported by the current X2. However, frame level coordination (10 ms), such as flexible TDD cross-link indication and coordination, might not be possible with the current X2 (from a latency point of view).
As an alternative to X2, a connection between two LA nodes might be realized by exploiting the link between an LA node and a macro node, i.e. building the LA node to LA node connections via macro cells. However, the delay induced by such a link might not be acceptable in most use cases requiring fast coordination.

Not many studies have been found for communications between base stations, besides the normal X2 link. This is most probably due to the fact that BS to BS communication is not well suited to technologies/deployments with one/many of the following characteristics:
Frequency division duplex (FDD) mode.
Large propagation delay between adjacent base stations (large inter-site distance).
Down-tilted and/or sectorized antenna system.
Different multiple access methods in downlink and uplink.

The main difficulties for an air link communication between BSs in such cases are:
It is difficult to find suitable cross-link resources for the BS-to-BS information exchange.
It is difficult to form a reliable air link between two base stations.

The present disclosure aims at solving at least some of the above problems. For example, an object of the disclosure is to provide a base station overhearing method of establishing a wireless link between base stations so that all the base stations may communicate with their neighbors with a limited overhead and reasonable delay.

This is at least in part achieved by the methods and apparatus defined in the appended claims. The present disclosure may also be implemented by computer program products.

A BS overhearing method according to at least one example version of the disclosure decreases the operator's CAPEX by enabling an X2-free deployment of an LTE network. Further, the BS overhearing method provides a latency that is on a par or better compared to the latency of X2, a robust BS-BS link for practical network deployments, and a flexible range of bit-rates that are potentially suitable for various applications, such as ICIC, CoMP, and SON.

A BS overhearing method according to at least one example version of the disclosure benefits from a symmetric uplink/downlink multiple access design such as OFDMA in both link directions, and may be introduced in LTE in a legacy compatible manner.

In addition, a BS overhearing method according to at least one example version of the disclosure facilitates the introduction of flexible TDD by allowing the exchange of ICIC information in the absence of X2 and providing opportunities for the BS-BS measurements.

Further features and advantages will become apparent from the following description of preferred embodiments, given by way of example only, which is made with reference to the accompanying drawings.

According to at least one example version of the disclosure, a method for base station overhearing is proposed, jointly considering the network and link level aspects.

As mentioned before, one of the key requirements for all ICIC schemes is the ability to exchange information between coordinated cells in order to track changes in interference conditions. Some examples of the ICIC related information are provided in the following:
Uplink/downlink configuration of a neighboring cell. This information may be used for the identification of the subframes with cross-link interference between two base stations.
Length of a PUCCH region. This information may be used for avoiding overlapping PDSCH/PUCCH allocations at resource blocks with heavy cross-link interference.
Positions of E-PDCCH resources. This information may be used for avoiding overlapping E-PDCCH/PUSCH allocations at resource blocks with significant cross-link interference.
List of protected PUSCH resources. This information may be used to protect the uplink data from cross-link interference (BS-to-BS).
List of protected PDSCH resources. This information may be used to protect downlink data from cross-link interference (UE-to-UE).

A BS overhearing method according to at least one example version of the disclosure provides ICIC related information exchange. In addition to the information exchange, the overhearing may be utilized for ICIC related measurements. One relevant application is the measurement of neighboring cell power levels, i.e., the coupling between two base stations. This information may be utilized as a basis for cell clustering.

Furthermore, the field of the base station to base station communication is not limited to ICIC, but relevant use cases may be found in other areas requiring fast information exchange between two base stations. Possible applications in LTE comprise e.g. coordinated multipoint access (CoMP), self-optimizing networks (SON), and handovers (HO).

Requirements for a link between two BSs may be summarized in that:
The delay of a BS-BS link should be sufficiently low, of the order of a couple of tens of milliseconds.
The BS-BS link should be reliable. This is a challenging requirement due to the large pathloss between adjacent base stations, compared to the pathloss at the cell edge.
The overhead should be limited. That is, the resources consumed by the BS-BS link should be a small fraction of the overall system resources, so that the overall system efficiency is not affected significantly.
There should be no significant impact on the system implementation complexity.
There should be no significant impact on the current frame structures, and the design should allow legacy UEs to access the system.

An air link between two base stations according to at least one example version of the disclosure is designed based on the above requirements.

At least one example version of the disclosure provides a coordinated information exchange between two base stations by means of base station overhearing, also named base station to base station over the air communication (BS-OTAC). At least one example version of the disclosure exploits the fact that, in TDD deployments, transmission and reception occur on the same frequency band. As a consequence, a victim cell/BS may overhear DL signals from its neighboring aggressor cells/BSs, given the victim cell/BS is configured to receive and the aggressor cells/BSs are configured to transmit at a certain subframe. In LTE, overhearing may be realized in an efficient and legacy compatible manner, as demonstrated in the following description.

According to an example version of the disclosure, a network deployment architecture is set for BS-BS overhearing so that all BSs (cells) of a communication network are divided into first to third groups (groups 1-3). Each group has its own dedicated resources for overhearing (e.g. a pattern of 3 time units, one time unit for UL, and two time units for DL). The BSs in the same group use the same resource pattern. Actual patterns are UL-DL-DL, DL-UL-DL, and DL-DL-UL for the 3 groups, respectively. One round of an overall overhearing process may be carried out in 3 time units.

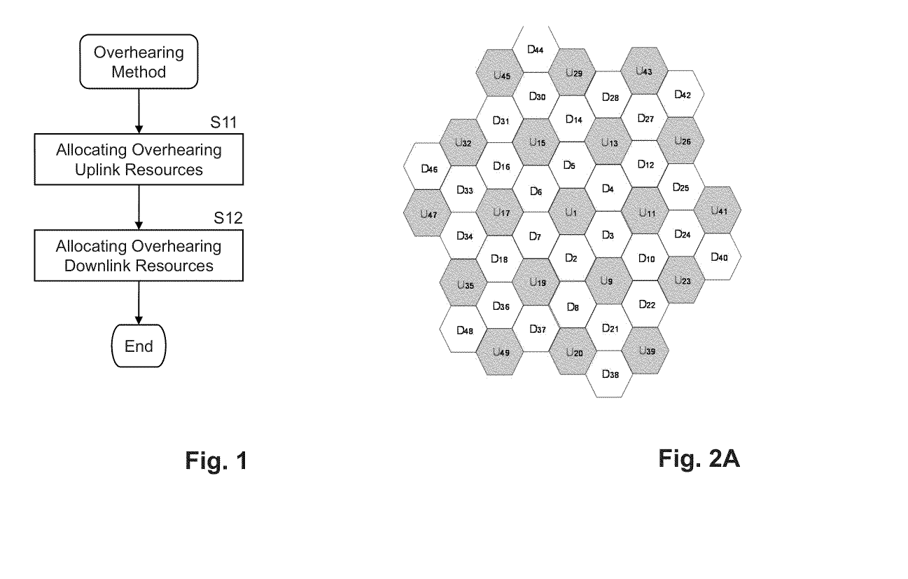

FIG. 1 shows a flowchart illustrating a BS overhearing method according to an example version of the disclosure. The method may be executed by a BS of the communication network. It is assumed that the BS belongs to a first group of BSs, where the communication network comprises the first group of BSs and second and third groups of BSs. The BS provides access to the communication network for UEs by communicating with the UEs via an air interface.

In step S11 of the BS overhearing method, overhearing uplink resources to be used for receiving data from BSs of the second and third groups are allocated in a frame used for communicating with the UEs.

In step S12, overhearing downlink resources for the second and third groups, to be used for transmitting data to BSs of the second and third groups, are allocated in the frame used for communicating with the UEs. Then the process is ended.

In the following, an implementation example of the BS overhearing method will be described, focusing on details of network deployment in an overhearing period.

A rule for the overhearing may be expressed as follows:

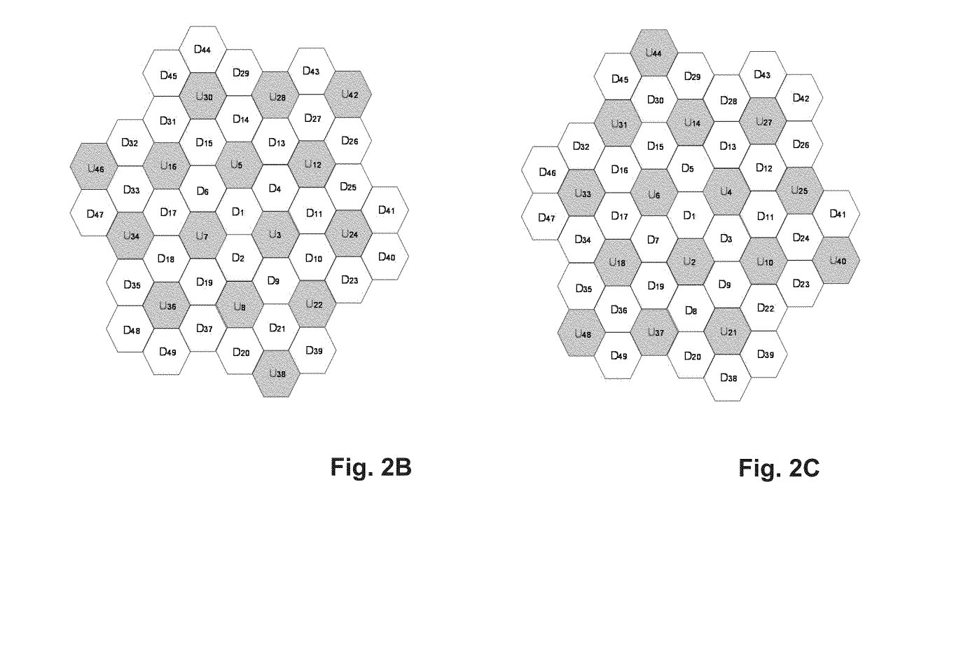

When a cell is given a time unit for overhearing (UL), all its neighboring cells (1st-tie) are set to DL for transmitting information (data) to be exchanged, as shown in FIGS. 2A-2C.

The detailed procedure may be expressed as follows:

1. In time unit #1, a number of cells in the network is selected to form a group based on the above rule (shadowed cells in FIG. 2A-2C). In this group, all the cells are set to UL for overhearing. Meanwhile, all other cells (not in this group) are set to DL for the transmissions of overheard information.

2. In time unit #2, based on the same rule, a group of cells is selected which are not in UL in time unit #1, and set to UL, while the rest of the cells are set to DL.

3. In time unit #3, based on the same rule, a group of cells is selected which are not in UL in time unit #1 and time unit #2, and set to UL, while the rest of cells are set to DL.

After the previous procedure (through 3 time units), it is found that:
All the cells in the network have been selected to one group.
No cell has been selected to different groups during the procedure.

Referring to the drawings, FIG. 2A shows a selection state in a network of 49 cells (BSs) at time unit #1. The cells selected for overhearing group #1 are shadowed. For example, cell #1 is selected in time unit #1 and set to UL (indicated by “U” in FIGS. 2A-2C), while its neighboring cells #2-#7 are set to DL (indicated by “D” in FIGS. 2A-2C).

In FIG. 2B, illustrating the selection state at time unit #2, cells #3, #5 and #7 are selected for UL (i.e. overhearing group #2), and cell #1 is set to DL.

In FIG. 2C, illustrating the selection state at time unit #3, cells #2, #4 and #6 are selected for UL (i.e. overhearing group #3), and cell #1 remains in DL.

As can be seen from FIGS. 2A-2C, the overall overhearing procedure may be completed in 3 time units. During the procedure, all the cells have chances to overhear their neighboring cells, and also have chances to be overheard by the neighboring cells.

The above procedure may be summarized as follows:
The cells are divided into 3 overhearing groups.
The cells of each group have the same UL/DL pattern for overhearing, i.e. UL-DL-DL, DL-UL-DL, or DL-DL-UL.
Each group utilizes 3 time units for overhearing, as:
One time unit is set to UL for overhearing the DL information transmitted from the neighboring cells (which belongs to the other two groups).
Two time units are set to DL for transmitting the information to be overheard to the neighboring cells (one each for another UL group).
The actual time domain patterns for overhearing are hence UL-DL-DL, DL-UL-DL, and DL-DL-UL.
The time unit may be anything from one OFDM symbol to multiple subframes.

Hence, information exchange between neighboring cells may be carried out through air link by overhearing.

An assumption for the described overhearing procedure is that the dominate inter-cell interference originates from the first tie of adjacent cells (6 cells), and only the first tie of neighboring cells can be coordinated.

In the following, sets of frame structures for overhearing according to example versions of the disclosure are described, which are based on the proposed network deployment architecture, and which are subframe based and GP/Orthogonal frequency division multiplexing (OFDM) symbol based.

Based on the proposed cell deployment scheme described above with respect to FIG. 1 and FIGS. 2A-2C, two overhearing frame structures based on different time scales are provided according to example versions of the disclosure, namely the subframe based frame structure and the guard period based frame structure.

Assumptions for the frame structure are:
In the subframe based scheme, a legacy incompatible frame structure is assumed for LTE, i.e., there is no special subframe.
In the GP/OFDM symbol based scheme, legacy TDD configurations are assumed for LTE, i.e., there is a special subframe every 5 or 10 ms.
In other words, referring to FIG. 1, in steps S11 and S12, the frame in which the overhearing uplink/downlink resources are allocated complies with a subframe based frame structure or a guard period based frame structure.

In the following, a subframe based frame structure for overhearing according to an example version of the disclosure will be described.

Two implementation examples of the example version of the disclosure are proposed for the subframe based frame structure for overhearing, based on the following considerations:
10 ms frame length with 1 ms subframe length.
1 common DL subframe (labeled as “Dc” in Tables 1 and 2 below) and 1 common UL subframe (labeled as “U_{C}” in Tables 1 and 2 below) for all TDD configurations (1 ms+1 ms).
3 dedicated subframes for overhearing (3 ms). The subframes used for overhearing the adjacent base stations are labeled as “O_{RX}” in Tables 1 and 2 below, while the subframes used for transmitting the information to be overheard are labeled as “O_{TX}”. It should be noticed that only a limited amount of resources (PRBs) in these 3 subframes are used for overhearing.
5 subframes are used as flexible TDD subframes (5 ms), labeled as “F” in Tables 1 and 2 below.
The switching between UL and DL (and vice versa) is limited to a minimum in each frame. In other words, the uplink and downlink subframes are allocated such that there is a minimum number of switches between uplink and downlink operations of the base station.
A short guard period needs to be accommodated per DL/UL switching period in order to account for the RX/TX and TX/RX switching.

TABLE 1
Subframe based frame structure for overhearing, option #1
Overhearing group #1

| | subframe | | | | | | | | | |
|---|---|---|---|---|---|---|---|---|---|---|
| | 0 | 1 | 2 | 3 | 4 | 5 | 6 | 7 | 8 | 9 |
| conf. | D_{C} | U_{C} | F | F | F | F | F | O_{RX} | O_{TX} | O_{TX} |
| 1 | D | U | D | D | D | D | D | U | D | D |
| 2 | D | U | U | D | D | D | D | U | D | D |
| 3 | D | U | U | U | D | D | D | U | D | D |
| 4 | D | U | U | U | U | D | D | U | D | D |
| 5 | D | U | U | U | U | U | D | U | D | D |
| 6 | D | U | U | U | U | U | U | U | D | D |

Overhearing group #2

| | subframe | | | | | | | | | |
|---|---|---|---|---|---|---|---|---|---|---|
| | 0 | 1 | 2 | 3 | 4 | 5 | 6 | 7 | 8 | 9 |
| conf. | D_{C} | U_{C} | F | F | F | F | F | O_{TX} | O_{RX} | O_{TX} |
| 1 | D | U | D | D | D | D | D | D | U | D |
| 2 | D | U | U | D | D | D | D | D | U | D |
| 3 | D | U | U | U | D | D | D | D | U | D |
| 4 | D | U | U | U | U | D | D | D | U | D |
| 5 | D | U | U | U | U | U | D | D | U | D |
| 6 | D | U | U | U | U | U | U | D | U | D |

Overhearing group #3

| | subframe | | | | | | | | | |
|---|---|---|---|---|---|---|---|---|---|---|
| | 0 | 1 | 2 | 3 | 4 | 5 | 6 | 7 | 8 | 9 |
| conf. | D_{C} | U_{C} | F | F | F | F | F | O_{TX} | O_{TX} | O_{RX} |
| 1 | D | U | D | D | D | D | D | D | D | U |
| 2 | D | U | U | D | D | D | D | D | D | U |
| 3 | D | U | U | U | D | D | D | D | D | U |
| 4 | D | U | U | U | U | D | D | D | D | U |
| 5 | D | U | U | U | U | U | D | D | D | U |
| 6 | D | U | U | U | U | U | U | D | D | U |

As can be seen from Table 1 above, subframes #0 and #1 are used as the common DL and UL subframes, subframes #2-#6 are used as the flexible TDD subframes, and subframes #7-#9 are used as the dedicated subframes for overhearing. There are in total 6 UL/DL configurations, 2 UL/DL switches, and 2 DL/UL switches per subframe (except for one switch for configuration 6 in group 1). The UL/DL range is from 2UL/8DL to 7UL/3DL. The uplink and downlink subframes in the configurations are allocated such that there is a minimum number of switches between uplink and downlink operations of the base station.

TABLE 2
Subframe based frame structure for overhearing, option #2
Overhearing group #1

| | subframe | | | | | | | | | |
|---|---|---|---|---|---|---|---|---|---|---|
| | 0 | | 2 | 3 | 4 | 5 | 6 | 7 | 8 | 9 |
| conf. | D_{C} | 1 | U_{C} | F | F | F | F | F | O_{RX} | O_{TX} |
| 1 | D | D | U | D | D | D | D | D | U | D |
| 2 | D | D | U | U | D | D | D | D | U | D |
| 3 | D | D | U | U | U | D | D | D | U | D |
| 4 | D | D | U | U | U | U | D | D | U | D |
| 5 | D | D | U | U | U | U | U | D | U | D |
| 6 | D | D | U | U | U | U | U | U | U | D |

Overhearing group #2

| | subframe | | | | | | | | | |
|---|---|---|---|---|---|---|---|---|---|---|
| | 0 | 1 | 2 | 3 | 4 | 5 | 6 | 7 | 8 | 9 |
| conf. | D_{C} | O_{TX} | U_{C} | F | F | F | F | F | O_{TX} | O_{RX} |
| 1 | D | D | U | D | D | D | D | D | D | U |
| 2 | D | D | U | U | D | D | D | D | D | U |
| 3 | D | D | U | U | U | D | D | D | D | U |
| 4 | D | D | U | U | U | U | D | D | D | U |
| 5 | D | D | U | U | U | U | U | D | D | U |
| 6 | D | D | U | U | U | U | U | U | D | U |

Overhearing group #3

| | subframe | | | | | | | | | |
|---|---|---|---|---|---|---|---|---|---|---|
| | 0 | 1 | 2 | 3 | 4 | 5 | 6 | 7 | 8 | 9 |
| conf. | D_{C} | O_{RX} | U_{C} | F | F | F | F | F | O_{TX} | O_{TX} |
| 1 | D | U | U | D | D | D | D | D | D | D |
| 2 | D | U | U | U | D | D | D | D | D | D |
| 3 | D | U | U | U | U | D | D | D | D | D |
| 4 | D | U | U | U | U | U | D | D | D | D |
| 5 | D | U | U | U | U | U | U | D | D | D |
| 6 | D | U | U | U | U | U | U | U | D | D |

As can be seen from Table 2 above, subframes #0 and #2 are used as the common DL and UL subframes, subframes #3-#7 are used as the flexible TDD subframes, and subframes #8, #9 and #1 are used as the dedicated subframes for overhearing. There are in total 6 UL/DL configurations, 2 UL/DL switches, 2 DL/UL switches for group 1 and 2, and 1 DL/UL switch for group 3. The UL/DL range is from 2UL/8DL to 7UL/3DL. The uplink and downlink subframes in the configurations are allocated such that there is a minimum number of switches between uplink and downlink operations of the base station.

In the following, physical channel mapping for the subframe based frame structure according to an example version of the disclosure will be explained.

A physical channel for overhearing is defined, denoted as physical overhearing channel (POCH). Mapping of the POCH to physical resources is described by the following rules:
A POCH transmitted between two bases stations is mapped to a physical resource block (PRB), or multiple physical resource blocks, which are (semi-) statically configured by network signaling. Since one BS overhears all its neighboring BSs (1^{st} tie), those neighboring BSs to be overheard should send their signals in an orthogonal manner (no interference with each other) so that the overhearing BS can detect them correctly. In the static scheme, the PRBs for each overheard BS are fixed (and orthogonal to the PRBs of other overheard BSs). In the semi-static scheme, the PRBs for each overheard BS can vary slowly (for instance, fixed over a few tens of frame durations) based on one or more criteria (such as channel conditions of PRBs), while keeping the orthogonality between the PRBs for different overheard BSs.
The two slots of a PRB belonging to one POCH are mapped to different frequency locations in order to improve frequency diversity. To avoid introducing unnecessary restrictions for PDSCH and PUSCH scheduling, and to achieve maximum frequency diversity, the POCH may be mapped to PRB(s) close to band edges.
The POCHs from the different (six) neighboring cells may be mapped to adjacent frequency resources, similar to current PUCCH.
No uplink control/data should be scheduled in the resources overlapping with POCH in order to guarantee (almost) interference-free reception of POCH.

Assuming QPSK modulation and the most robust channel coding for PDCCH (CR=0.1), there are 34 overhearing bits available per PRB. Assuming one PRB per POCH, 6 cells to be overheard, and 20 MHz bandwidth, the resulting overhead due to POCH transmission is (6*3)/(100*10)=1.8%. The overhearing delay is 10 ms.

In the following, a guard period based frame structure for overhearing according to an example version of the disclosure will be described.

In the current TDD frame structure of LTE, there is a special subframe S every 5 or 10 ms, containing the switching point from DL to UL. Inside this special subframe is a blank guard period (GP) (1-10 OFDM symbols), which is used for UL synchronization by the timing advance procedure of LTE and to allow some time for the BS and UE to switch their transmission directions.

In a LA environment, a cyclic prefix (CP) part of an OFDM symbol (which is about 4.7 us) may be utilized not only to account for a channel delay spread, but also to account for a timing advance needed for the UL synchronization. As a consequence, it becomes possible to overhear a multiple of adjacent base stations during one OFDM symbol, given the timing errors are within the CP.

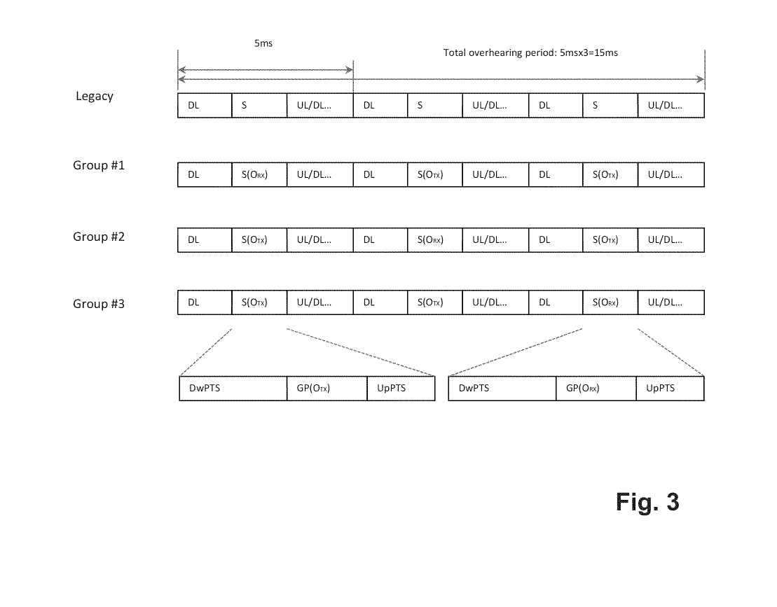

FIG. 3 shows the GP/OFDM symbol based frame structure for overhearing according to the example version of the disclosure. In the special subframe S, the GP is used for overhearing/transmitting the information (data) to be overheard, which is indicated by “GP (O_{RX})” and “GP(O_{TX})” in FIG. 3. In other words, with respect to Group #1, for example, the overhearing uplink resources are allocated in at least one OFDM symbol of a guard period of a special subframe of a first half-frame (comprising the first 5 ms of the total overhearing period in FIG. 3 for Group #1) of a frame (comprising the first 10 ms of the total overhearing period in FIG. 3), the overhearing downlink resources for the second group are allocated in at least one OFDM symbol of a guard period of a special subframe of a second half-frame (comprising the second 5 ms of the total overhearing period in FIG. 3 for Group #1) of the frame, and the overhearing downlink resources for the third group are allocated in at least one OFDM symbol of a guard period of a special subframe of a first half-frame (comprising the third 5 ms of the total overhearing period in FIG. 3 for Group #1) of a consecutive frame.

As can be seen from FIG. 3, the overhearing delay is 15 ms assuming the 5 ms periodicity for the special subframe S, and 30 ms assuming the 10 ms periodicity for the special subframe S.

In the following, physical channel mapping for the guard period based frame structure according to an example version of the disclosure will be explained.

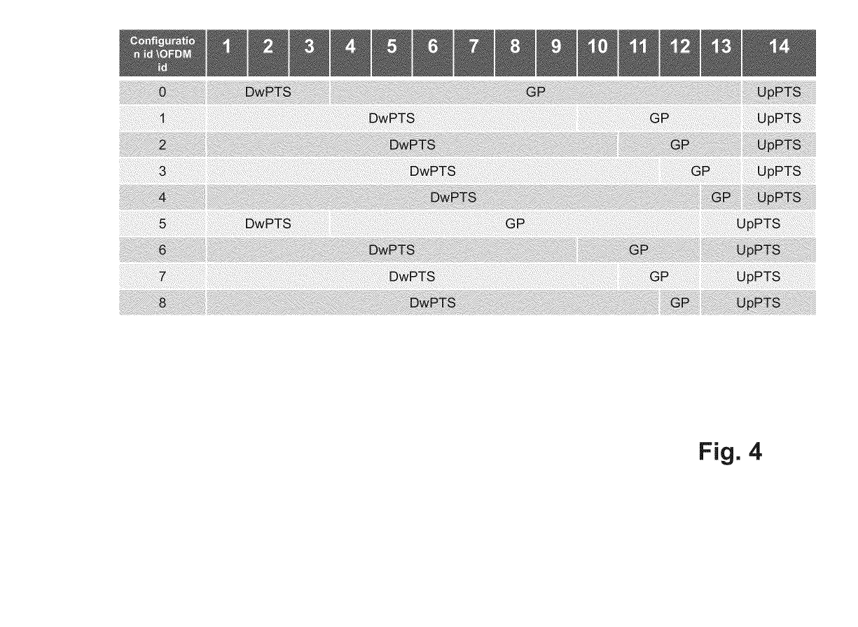

There are nine different special subframe configurations in LTE as shown in FIG. 4, providing six GP durations. Each configuration may be potentially used for overhearing.

In the following, an implementation example of the disclosure will be described as to how the resources in the special subframe of LTE may be utilized for BS-BS communications.

As a starting point, legacy UEs (supporting LTE release 8, 9, 10, or 11) should be able to utilize downlink resources during the special subframes. This may be realized by configuring special subframe configurations #0, 1, 2, or 3 illustrated in FIG. 4, for such UEs, while the overhearing is carried out at the remaining OFDM symbols of the subframe.

As a consequence, there are five possible subframe configurations for the overhearing during special subframes, providing 1, 2, 3, 9, or 12 OFDM symbols for the POCH transmission. Note that the last configuration is somewhat a special case, implying no downlink data transmission for the legacy UEs.

The proposed time-domain configurations during special subframes are illustrated in Table 3 below.

TABLE 3
Special subframe configurations for GP based overhearing
Configuration 1: 1 OFDM symbol for overhearing

| Downlink data | | | | | | | | | | | ? | OH- | GP |
|---|---|---|---|---|---|---|---|---|---|---|---|---|---|
| | | | | | | | | | | | | TX | |
| Downlink data | | | | | | | | | | | GP | OH- | ? |
| | | | | | | | | | | | | RX | |
| DwPTS (conf 3) | | | | | | | | | | | GP | | UpPTS |
| 0 | 1 | 2 | 3 | 4 | 5 | 6 | 7 | 8 | 9 | 10 | 11 | 12 | 13 |

Configuration 2: 2 OFDM symbols for overhearing

| | | | | |
|---|---|---|---|---|
| Downlink data | ? | OH- | OH- | GP |
| | | TX | TX | |
| Downlink data | GP | OH- | OH- | ? |
| | | RX | RX | |
| DwPTS (conf 2) | GP | | | UpPTS |

Configuration 3: 3 OFDM symbols for overhearing

| | | | | | |
|---|---|---|---|---|---|
| Downlink data | ? | OH- | OH- | OH- | GP |
| | | TX | TX | TX | |
| Downlink data | GP | OH- | OH- | OH- | ? |
| | | RX | RX | RX | |
| DwPTS (conf 1) | GP | | | | UpPTS |

Configuration 4: 9 OFDM symbols for overhearing

| | | | | | | | | | | | |
|---|---|---|---|---|---|---|---|---|---|---|---|
| Downlink data | ? | OH- | OH- | OH- | OH- | OH- | OH- | OH- | OH- | OH- | GP |
| | | TX | TX | TX | TX | TX | TX | TX | TX | TX | |
| Downlink data | GP | OH- | OH- | OH- | OH- | OH- | OH- | OH- | OH- | OH- | ? |
| | | RX | RX | RX | RX | RX | RX | RX | RX | RX | |
| DwPTS (conf 0) | GP | | | | | | | | | | UpPTS |

Configuration 5: 12 OFDM symbols for overhearing

| | | | | | | | | | | | | | |
|---|---|---|---|---|---|---|---|---|---|---|---|---|---|
| ? | OH- | OH- | OH- | OH- | OH- | OH- | OH- | OH- | OH- | OH- | OH- | OH- | GP |
| | TX | TX | TX | TX | TX | TX | TX | TX | TX | TX | TX | TX | |
| GP | OH- | OH- | OH- | OH- | OH- | OH- | OH- | OH- | OH- | OH- | OH- | OH- | ? |
| | RX | RX | RX | RX | RX | RX | RX | RX | RX | RX | RX | RX | |
| GP | | | | | | | | | | | | | UpPTS |

The following notation is adopted:
The first row in Table 3 shows an allocation of OFDM symbols for Rel' 12 UEs in an aggressor (i.e. non-overhearing) cell.
The second row shows an allocation of OFDM symbols for Rel' 12 UEs in a victim (overhearing) cell.
The third row shows the allocation of OFDM symbols for Rel' 8-11 UEs in either an aggressor or a victim cell.
Characters in bold denote an uplink transmission.
An overhearing transmission is denoted as OH-TX while an overhearing reception is denoted as OH-RX.
A guard period is denoted as GP.

A downlink OFDM symbol with a question mark may be utilized to transmit Rel-12 specific signaling, such as uplink-downlink configurations, to non-legacy UEs. In addition, this symbol may be utilized to extend downlink resource blocks for Rel-12 UEs in a non-backward compatible manner.

Symbol #13 in Table 3 may be utilized to transmit SRS to legacy and Rel-12 UEs, as in earlier releases. Another possibility is to skip the SRS transmission, but instead exchange some control data from Rel-12 UEs in the slot marked with question mark.

The overhearing configurations above may be exploited as follows.

A physical channel with fixed bit-rate and fixed robustness across a wide range of channel bandwidths may be provided. For example, assuming 1 OFDM symbol (configuration 1 in Table 3) reserved for a 20 MHz POCH, 2 OFDM symbols are needed for 10 MHz, 4 OFDM symbols for 5 MHz, 7 OFDM symbols for 3 MHz, and 17 OFDM symbols for 1.4 MHz. Note that the downlink spectrum efficiency of the legacy UEs is lower for the smaller channel bandwidths.

A physical channel with flexible bit-rate and fixed robustness across a limited range of channel bandwidths may be provided. This approach may be especially feasible in local area networks, where the two highest bandwidth options are expected to dominate. As with the first option, the spectrum efficiency of the legacy UEs potentially suffers when utilizing configurations with a longer GP.

As explained with respect to FIGS. 2A-2C, an overhearing base station listens to up to 6 of its neighbor base stations per subframe. For the GP based frame structure solution, this may be realized with a multiple of channel mapping schemes, based on FDM, TDM, and possibly CDM, or a mixture of those. In any case, the aggressor cells should have assigned orthogonal resources in order to limit the interference during the overhearing period.

Regarding coverage, FDM or FDM/CDM may be preferred so as to maximize the link reliability.

Alternatives for frequency domain multiplexing include frequency localized or frequency distributed approaches. In practice, a mixture of those (such as a block interleaved scheme) may be used in order to find the right balance between frequency diversity and pilot overhead.

Assuming QPSK modulation, 20 MHz channel bandwidth, and similar coding rate as for PDCCH with the highest aggregation level (CR=0.1), there are 240 bits per OFDM symbol for overhearing 6 neighboring base stations, implying 40 bits per BS-to-BS connection. The resulting overhead is 1/(14*5)=1.4% per OFDM symbol.

In the follow, an analysis of the link reliability of BS overhearing will be given.

The link reliability is one of the critical issues of BS overhearing. In the following, the BS-BS link reliability is analyzed by comparing BS→BS, BS→UE, and UE→BS link budgets.

Table 4 shows the budgets for BS-BS, BS-UE, and UE-BS links. The purpose is to estimate a maximum inter-site distance (ISD) for BS to BS communications.

TABLE 4

| | | UE −> | BS −> | BS −> | |
|---|---|---|---|---|---|
| Parameter | Formula | BS | UE | BS | Unit |
| Frequency band | f | 3500 | 3500 | 3500 | MHz |
| Cell radius | d | 122 | 122 | 478 | m |
| Transmission | | 1 | 100 | 16.7 | RB |
| bandwidth | | 0.18 | 18 | 3 | MHz |
| Transmission | A | 23.0 | 30.0 | 30.0 | dBm |
| Power | | | | | |
| TX Antenna Gain | B | 0.0 | 5.0 | 5.0 | dBi |
| Body/cable loss | C | 0.0 | 0.0 | 0.0 | dB |
| EIRP | D = A + B − C | 23.0 | 35.0 | 35.0 | dBm |
| Receiver Noise | E | 3.0 | 8.0 | 3.0 | dB |
| Figure | | | | | |
| Thermal Noise | F | −174.0 | −174.0 | −174.0 | dBm/Hz |
| Density | | | | | |
| Receiver Noise | G = E + F + | −118.4 | −93.4 | −106.2 | dBm |
| Power | 10log10(BW) | | | | |
| Required SINR | H | −4.0 | −4.0 | −4.0 | dB |
| Interference | I = SNR/SINR | 6.0 | 6.0 | 0.0 | dB |
| margin | | | | | |
| Receiver | J = G + H + I | −116.4 | −91.4 | −110.2 | dBm |
| Sensitivity | | | | | |
| Cable/body loss | K | 0.0 | 0.0 | 0.0 | dB |
| RX Antenna Gain | L | 5.0 | 0.0 | 5.0 | dB |
| (dBi) | | | | | |
| Fast fading | M | 0.0 | 0.0 | 0.0 | dB |
| margin | | | | | |
| Maximum | R = D − J + | 144.4 | 126.4 | 150.2 | dB |
| coupling loss | K + L − M | | | | |
| Pathless at 1 m | L0 | 43 | 43 | 43 | dB |
| Pathloss exponent | n | 4 | 4 | 4 | |
| Pathloss | L = L0 + | 126.4 | 126.4 | 150.2 | dB |
| | 10*n*log(d) | | | | |

The calculations above are based on the following key assumptions:
The uplink coverage is determined based on a UE transmitting on a single PRB (such as PUCCH).
The downlink coverage is determined based on a BS transmitting over the full bandwidth (i.e. there is no power control in downlink).
The BS-BS coverage is determined based on the aggressor BS transmitting on 100/6=16.7 PRBs (assuming the GP based method). In other words there is a maximum power boosting for the overhearing channel.
The BS has a maximum transmit power of 30 dBm which is typical for pico cells.
There is a 5 dB difference between the sensitivities of BS and UE.
There is no interference margin for the BS-BS link due to orthogonal POCH resources.
There is a 5 dB difference between the antenna gains of BS and UE.
A high pathloss exponent is chosen to approximate severe distance-based attenuation conditions.

Based on the calculations in Table 4, it is found that the aggressor base station may be overheard from a distance that is approximately 2 times the ISD. The cell coverage is limited by the downlink (BS-UE) budget.

A more detailed breakdown of the link budget is provided in the following:

As a starting point, the BS-BS link budget is 12 dB worse compared to the BS-UE link budget due to the distance-dependent pathloss (n=4).

However, this 12 dB difference is compensated by a multiple of factors:
There is 5 dB compensation due to the different antenna gains of BS and UE.
There is 5 dB compensation due to the different sensitivities of BS and UE.
There is 7.8 dB compensation due to power boosting.
There is 6 dB compensation due to zero interference margin.

As a net effect, there is a 13.8 dB difference between the link budgets of BS-BS and BS-US, in the favor of BS-BS. Hence the overhearing is feasible from the link reliability point of view in irregular network deployments where the ISD between the victim base station and the first tie of aggressor base stations has some significant variance.

If needed, the BS-BS link budget may be further improved e.g. by means of beam-forming or receiver based IC techniques.

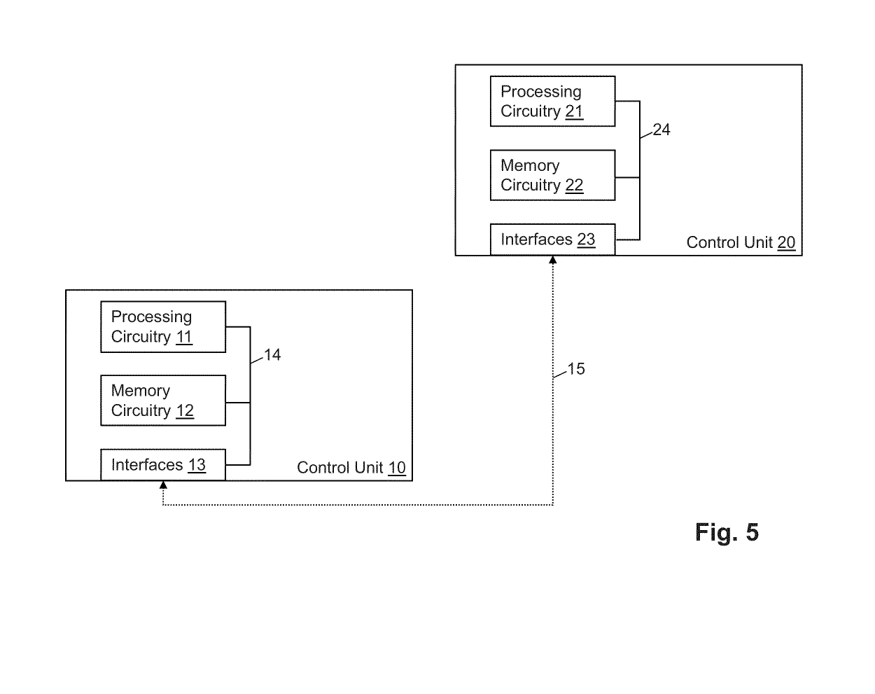

Reference is now made to FIG. 5 for illustrating a simplified block diagram of various electronic devices that are suitable for use in practicing the example versions of this disclosure.

A control unit 10 which may be part of and/or used by a base station of a communication network comprises a processing system and/or processing circuitry 11, a memory circuitry 12 which may store a program, and interfaces 13 which are connected by a link 14.

Similarly, a control unit 20 which may be part of and/or used by a base station of a communication network comprises a processing system and/or processing circuitry 21, a memory circuitry 22 which may store a program, and interfaces 23 which are connected by a link 24.

The control units 10, 20 communicate over a link 15 according to the above-described overhearing methods. The control units 10, 20 may be used for executing the process illustrated in FIG. 1.

The interfaces 13, 23 may include a suitable radio frequency (RF) transceiver coupled to one or more antennas (not shown) for bidirectional wireless communications over the link 15.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements may be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The programs stored in the memory circuitries 12, 22 are assumed to include program instructions that, when executed by the associated processing circuitry 11, 21, enable the electronic device to operate in accordance with the example versions of this disclosure, as detailed above. Inherent in the processing circuitries 11, 21 is a clock to enable synchronism amongst the various apparatus for transmissions and receptions within the appropriate time intervals and slots required, as the scheduling grants and the granted resources/subframes are time dependent. The transceivers include both transmitter and receiver, and inherent in each is a modulator/demodulator commonly known as a modem.

In general, the example versions of this disclosure may be implemented by computer software stored in the memory circuitries 12, 22 and executable by the processing circuitries 11, 21, or by hardware, or by a combination of software and/or firmware and hardware in any or all of the devices shown.

The memory circuitries 12, 22 may be of any type suitable to the local technical environment and may be implemented using any suitable data storage technology, such as semiconductor based memory devices, magnetic memory devices and systems, optical memory devices and systems, fixed memory and removable memory. The processing circuitries 11, 21 may be of any type suitable to the local technical environment, and may include one or more of general purpose computers, special purpose computers, microprocessors, digital signal processors (DSPs) and processors based on a multi core processor architecture, as non limiting examples.

As used in this application, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to an aspect of the disclosure, an apparatus for use in a base station of a communication network is provided, the base station belonging to a first group of base stations and the communication network comprising the first group of base stations and second and third groups of base stations, the base station providing access to the communication network for user equipments by communicating with the user equipments via an air interface. The apparatus may comprise and/or use the control unit 10.

The apparatus comprises means for allocating overhearing uplink resources to be used for receiving data from base stations of the second and third groups, in a frame used for communicating with the user equipments, and means for allocating overhearing downlink resources for the second and third groups, to be used for transmitting data to base stations of the second and third groups, in the frame used for communicating with the user equipments.

According to an example version of the disclosure, the overhearing uplink resources comprise resources of one time unit, the overhearing downlink resources for the second group comprise resources of one time unit, and the overhearing downlink resources for the third group comprise resources of one time unit.

According to an example version of the disclosure, the time unit comprises at least one OFDM symbol and/or at least one subframe.

According to an example version of the disclosure, a pattern of the order of the allocated overhearing uplink resources, the allocated overhearing downlink resources for the second group and the allocated overhearing downlink resources for the third group in the frame differs between the first to third groups of base stations.

According to an example version of the disclosure, the base stations of the second and third groups comprise base stations of neighboring cells of a cell of the base station.

According to an example version of the disclosure, a cell of the communication network belongs to one of the first to third groups.

According to an example version of the disclosure, the frame complies with a subframe based frame structure or a guard period based frame structure.

According to an example version of the disclosure, the frame complies with the subframe based frame structure, and the means for allocating the overhearing uplink resources allocate the overhearing uplink resources in a first subframe of the frame, and the means for allocating the overhearing downlink resources allocate the overhearing downlink resources for the second group in a second subframe of the frame, and the overhearing downlink resources for the third group in a third subframe of the frame.

According to an example version of the disclosure, the apparatus comprises means for allocating uplink and downlink subframes in the remainder of the frame such that there is a minimum number of switches between uplink and downlink operations of the base station.

According to an example version of the disclosure, the apparatus comprises means for allocating a downlink subframe common to all TDD configurations which are provided, and means for allocating an uplink subframe common to all the TDD configurations.

According to an example version of the disclosure, the apparatus comprises means for allocating subframes in the remainder of the frame as flexible TDD subframes.

According to an example version of the disclosure, the apparatus comprises means for mapping a channel, which is used for receiving and/or transmitting the data between the base station and a base station of the second or third group, to at least one statically or semi-statically configured physical resource block, means for mapping slots of the physical resource block to different frequency locations, and means for mapping channels between the base station and base stations of neighboring cells of a cell of the base station to adjacent frequency resources.

According to an example version of the disclosure, the frame complies with a guard period based frame structure, and the means for allocating the overhearing uplink resources allocate the overhearing uplink resources in at least one OFDM symbol of a guard period of a special subframe of a first half-frame of the frame, and the means for allocating the overhearing downlink resources allocates the overhearing downlink resources for the second group in at least one OFDM symbol of a guard period of a special subframe of a second half-frame of the frame, and the overhearing downlink resources for the third group in at least one OFDM symbol of a guard period of a special subframe of a first half-frame of a consecutive frame.

According to an example version of the disclosure, the special subframes of the first and second half-frames are subframes containing a switching point from downlink to uplink operation of the base station.

According to an example version of the disclosure, a guard period duration of a specific number of OFDM symbols is used for allocating the overhearing uplink resources and the overhearing downlink resources for the second and third groups.

According to an example version of the disclosure, the specific number of OFDM symbols is any one of 1, 2, 3, 9 or 12.

According to an example version of the disclosure, the data received from the base stations of the second and third groups, using the overhearing uplink resources, and/or the data transmitted to the base stations of the second and third groups, using the overhearing downlink resources, comprises at least one of the following:
uplink/downlink configuration of a neighboring cell,
length of a PUCCH (physical uplink control channel) region,
positions of E-PDCCH (evolved PDCCH) resources,
list of protected PUSCH (physical uplink shared channel) resources,
list of protected PDSCH (physical downlink shared channel) resources, and
measurement of neighboring cell power levels.

The means for allocating and mapping may be implemented by the processing circuitry 11 and the memory circuitry 12 of the control unit 10. In addition, the interfaces 13 of the control unit 10 may be used for implementing the means for allocating and mapping.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for use by a base station of a communication network, the base station belonging to a first group of base stations and the communication network comprising the first group of base stations and second and third groups of base stations, the base station providing access to the communication network for user equipments by communicating with the user equipments via an air interface, the method comprising:
allocating overhearing uplink resources to be used for receiving data from base stations of the second and third groups, in a frame used for communicating with the user equipments; and
allocating overhearing downlink resources for the second and third groups, to be used for transmitting data to base stations of the second and third groups, in the frame used for communicating with the user equipments.

2. The method according to claim 1, wherein the overhearing uplink resources comprise resources of one time unit, the overhearing downlink resources for the second group comprise resources of one time unit, and the overhearing downlink resources for the third group comprise resources of one time unit,
wherein a pattern of the order of the allocated overhearing uplink resources, the allocated overhearing downlink resources for the second group and the allocated overhearing downlink resources for the third group in the frame differs between the first to third groups of base stations.

3-7. (canceled)

8. The method according to claim 1, wherein the frame complies with a subframe based frame structure, and the method comprises:
allocating the overhearing uplink resources in a first subframe of the frame, allocating the overhearing downlink resources for the second group in a second subframe of the frame, and allocating the overhearing downlink resources for the third group in a third subframe of the frame.

9. The method according to claim 8, comprising:
allocating uplink and downlink subframes in the remainder of the frame such that there is a minimum number of switches between uplink and downlink operations of the base station; and/or
allocating a downlink subframe common to all TDD (time domain division) configurations which are provided, and allocating an uplink subframe common to all the TDD configurations; and/or
allocating subframes in the remainder of the frame as flexible TDD subframes.

10. The method according to claim 8, comprising:
mapping a channel, which is used for receiving and/or transmitting the data between the base station and a base station of the second or third group, to at least one statically or semi-statically configured physical resource block;
mapping slots of the physical resource block to different frequency locations; and
mapping channels between the base station and base stations of neighboring cells of a cell of the base station to adjacent frequency resources.

11. The method according to claim 1, wherein the frame complies with a guard period based frame structure, and the method comprises:
allocating the overhearing uplink resources in at least one OFDM symbol of a guard period of a special subframe of a first half-frame of the frame, allocating the overhearing downlink resources for the second group in at least one OFDM symbol of a guard period of a special subframe of a second half-frame of the frame, and allocating the overhearing downlink resources for the third group in at least one OFDM symbol of a guard period of a special subframe of a first half-frame of a consecutive frame.

12-13. (canceled)

14. A non-transitory computer-readable medium storing a computer program product including a program for a processing circuitry, comprising software code portions for performing the steps of:
allocating overhearing uplink resources to be used for receiving data from base stations of the second and third groups, in a frame used for communicating with the user equipments; and
allocating overhearing downlink resources for the second and third groups, to be used for transmitting data to base stations of the second and third coups, in the frame used for communicating with the user equipments.

15-16. (canceled)

17. An apparatus for use in a base station of a communication network, the base station belonging to a first group of base stations and the communication network comprising the first group of base stations and second and third groups of base stations, the base station providing access to the communication network for user equipments by communicating with the user equipments via an air interface, the apparatus comprising a processing circuitry configured to cause the apparatus at least to:
allocate overhearing uplink resources to be used for receiving data from base stations of the second and third groups, in a frame used for communicating with the user equipments; and
allocate overhearing downlink resources for the second and third groups, to be used for transmitting data to base stations of the second and third groups, in the frame used for communicating with the user equipments.

18. The apparatus according to claim 17, wherein the overhearing uplink resources comprise resources of one time unit, the overhearing downlink resources for the second group comprise resources of one time unit, and the overhearing downlink resources for the third group comprise resources of one time unit.

19. The apparatus according to claim 18, wherein the one time unit comprises at least one OFDM (orthogonal frequency division multiplexing) symbol and/or at least one subframe.

20. The apparatus according to claim 17, wherein a pattern of the order of the allocated overhearing uplink resources, the allocated overhearing downlink resources for the second group and the allocated overhearing downlink resources for the third group in the frame differs between the first to third groups of base stations.

21. The apparatus according to claim 17, wherein the base stations of the second and third groups comprise base stations of neighboring cells of a cell of the base station.

22. The apparatus according to claim 21, wherein a cell of the communication network belongs to one of the first to third groups.

23. The apparatus according to claim 17, wherein the frame complies with one of a subframe based frame structure and a guard period based frame structure.

24. The apparatus according to claim 23, wherein the frame complies with the subframe based frame structure, and the processing system is configured to cause the apparatus to:
allocate the overhearing uplink resources in a first subframe of the frame, allocate the overhearing downlink resources for the second group in a second subframe of the frame, and allocate the overhearing downlink resources for the third group in a third subframe of the frame.

25. The apparatus according to claim 24, wherein the processing system is configured to cause the apparatus to:
allocate uplink and downlink subframes in the remainder of the frame such that there is a minimum number of switches between uplink and downlink operations of the base station; and/or
allocate a downlink subframe common to all TDD (time domain division) configurations which are provided, and allocating an uplink subframe common to all the TDD configurations; and/or allocate subframes in the remainder of the frame as flexible TDD subframes.

26. The apparatus according to ciaim 24, wherein the processing system is configured to cause the apparatus to:
map a channel, which is used for receiving and/or transmitting the data between the base station and a base station of the second or third group, to at least one statically or semi-statically configured physical resource block;
map slots of the physical resource block to different frequency locations; and
map channels between the base station and base stations of neighboring cells of a cell of the base station to adjacent frequency resources.

27. The apparatus according to claim 23, wherein the frame complies with the guard period based frame structure, and the processing system is configured to cause the apparatus to:
allocate the overhearing uplink resources in at least one OFDM symbol of a guard period of a special subframe of a first half-frame of the frame, allocate the overhearing downlink resources for the second group in at least one OFDM symbol of a guard period of a special subframe of a second half-frame of the frame, and allocate the overhearing downlink resources for the third group in at least one OFDM symbol of a guard period of a special subframe of a first half-frame of a consecutive frame.

28. The apparatus according to claim 27, wherein:
the special subframes of the first and second half-frames are subframes containing a switching point from downlink to uplink operation of the base station; and/or
a guard period duration of a specific number of OFDM symbols is used for allocating the overhearing uplink resources and the overhearing downlink resources for the second and third groups.

29. The apparatus according to claim 17, wherein the data received from the base stations of the second and third groups using the overhearing uplink resources, and/or the data transmitted to the base stations of the second and third groups using the overhearing downlink resources, comprises at least one of the following:
uplink/downlink configuration of a neighboring cell,
a length of a PUCCH (physical uplink control channel) region,
posistions of E-PDCCH (evolved PDCCH) resources,
a list of protected PUSCH (physical uplink shared channel) resources,
a list of protected PDSCH (physical downlink shared channel) resources, and
measurement of neighboring cell power levels.

30. (canceled)
